(19) United States
(12) Patent Application Publication
(10) Pub. No.: US 2023/0227352 A1
(43) Pub. Date: Jul. 20, 2023

(54) METHOD OF BESSEL BEAM LASER PROCESSING FOR FORMING THROUGH GLASS VIAS

(71) Applicant: E & R ENGINEERING CORPORATION, KAOHSIUNG CITY (TW)

(72) Inventor: SCHANG-JING HON, KAOHSIUNG CITY (TW)

(21) Appl. No.: 17/653,147

(22) Filed: Mar. 2, 2022

(30) Foreign Application Priority Data
Jan. 17, 2022 (TW) 111101860

(51) Int. Cl. C03C 23/00; G02B 27/09; C03C 15/02

(52) U.S. Cl. CPC C03C 23/0025; G02B 27/0955; G02B 27/0927; C03C 15/02

(57) ABSTRACT

A method of Bessel beam laser processing for forming through glass vias is adapted for processing a glass substrate having a thickness of less than or equal to 1000 micrometers. The glass substrate is processed by a Bessel beam laser to form a pilot through via and is etched to enlarge the pilot through via to form a through glass via having a diameter ranging from 25 micrometers to 200 micrometers. The Bessel beam laser has a pulse width ranging from 10 picoseconds to 20 picoseconds and is converted as a Bessel beam passing through the glass substrate to form the pilot through via. The through glass via with a smooth interior surface is formed.

### BACKGROUND OF THE INVENTION

### 1. Field of the Invention

The present invention relates to a method for forming through glass vias (TGV), and more particularly to a method by using a Bessel beam laser to form pilot through vias in a glass substrate, and then etching the glass substrate to enlarge the pilot through vias to form through glass vias in the glass substrate.

### 2. Description of the Prior Art

Laser processing has been applied for forming through glass vias. One of the conventional methods for forming through glass vias is using a laser beam to irradiate a glass substrate to form modification regions, and etching the modification regions to form through glass vias.

However, a Gaussian beam deteriorates over distance, depth of focus (DOF) thereof is short, so the Gaussian beam needs to be focused at multiple depths one by one in the glass substrate to form a modification region along a thickness direction of the glass substrate, thereby increasing manufacturing lead time. In addition, because the Gaussian beam is focused at multiple depths one by one, the through glass vias will be formed with uneven interior surfaces.

A Bessel beam with a long depth of focus is suitable to be applied to the laser processing method for forming micro vias with high aspect ratio (HAR). A Bessel beam is generated from a Gaussian beam passing through a Bessel beam lens module to convert to the Bessel beam. The Bessel beam is non-diffracting, and maintains an unchanged transversal distribution of intensity as it propagates along a direction of beam propagation. The Bessel beam can apply uniform laser fluence through the glass substrate within a range of focal line length of the Bessel beam to form a pilot through via with high aspect ratio and a modification region surrounding the pilot through via in the glass substrate. Then, the glass substrate is etched to remove the modification region to enlarge a diameter of the pilot through via to form a through glass via of a specific size.

However, the glass substrate is made of a brittle material, cracks are easily formed in the glass substrate during processing for forming the through glass vias. The cracks cause the through glass vias with rough and uneven interior surfaces, thereby negatively affecting quality of a final product. Therefore, preferred processing parameters of a laser processing for reducing cracks in the glass substrate to form the through glass vias with smooth interior surfaces and good quality is needed.

To overcome the shortcomings, the present invention provides a method of Bessel beam laser processing for forming through glass vias to mitigate or obviate the aforementioned problems.

### SUMMARY OF THE INVENTION

The main objective of the present invention is to provide a method of Bessel beam laser processing for forming through glass vias, which is adapted for processing a glass substrate having a thickness of less than or equal to 1000 micrometers (μm). The glass substrate is processed by the Bessel beam laser, and is etched to form a through glass via with a smooth interior surface.

To achieve the foregoing purpose, the method of Bessel beam laser processing for forming through glass vias is adapted for processing a glass substrate having a thickness of less than or equal to 1000 micrometers, the glass substrate is processed by a Bessel beam laser to form a pilot through via, and is etched to enlarge the pilot through via to form a through glass via having a diameter ranging from 25 micrometers to 200 micrometers, wherein:

the Bessel beam laser has a pulse width ranging from 10 picoseconds to 20 picoseconds and is converted to a Bessel beam via a Bessel beam lens module, a focal line length of the Bessel beam is larger than or equal to the thickness of the glass substrate, and the Bessel beam passes through the glass substrate to form the pilot through via.

Preferably, the Bessel beam laser outputs energy ranging from 130 micro Joules to 220 micro Joules, per pulse width and per millimeter of the focal line length of the Bessel beam.

Preferably, the Bessel beam laser outputs energy ranging from 130 micro Joules to 140 micro Joules, per pulse width and per millimeter of the focal line length of the Bessel beam when the pulse width is 10 picoseconds.

Preferably, the Bessel beam laser outputs energy ranging from 155 micro Joules to 220 micro Joules, per pulse width and per millimeter of the focal line length of the Bessel beam when the pulse width is 20 picoseconds.

Preferably, the thickness of the glass substrate is less than or equal to 700 micrometers.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view showing that a glass substrate is processed by a Bessel beam laser in accordance with the present invention;

FIG. 2 is an enlarged cross sectional side view of the glass substrate having a pilot through via after the Bessel beam laser processing in FIG. 1;

FIG. 3 is an enlarged cross sectional side view of the glass substrate having through glass vias, wherein the glass substrate is processed by the Bessel beam laser having a pulse width of 10 picoseconds, and then is etched to form the through glass vias;

FIG. 4 is a roughness chart of an interior surface of the through glass vias in FIG. 3;

FIG. 5 is an enlarged cross sectional side view of the glass substrate having through glass vias, wherein the glass substrate is processed by the Bessel beam laser having a pulse width of 7 picoseconds, and then is etched to form the through glass vias; and

FIG. 6 is a roughness chart of an interior surface of the through glass vias in FIG. 5.

### DETAILED DESCRIPTION OF THE PREFERRED EMBODIMENTS

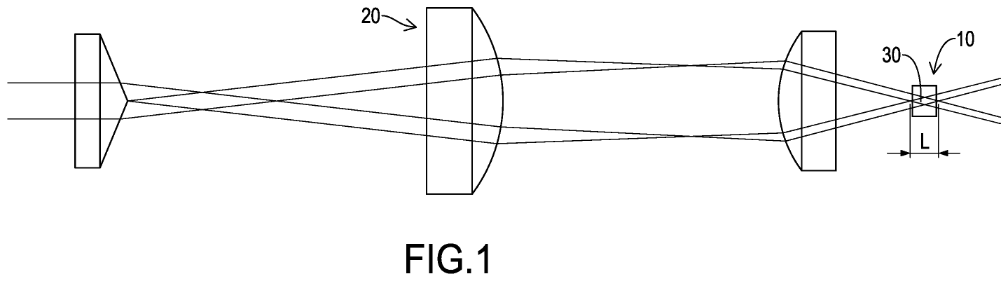

With reference to FIGS. 1 to 3, a mothed of Bessel beam laser processing for forming through glass vias (TGV) is adapted for processing a glass substrate 10 having a thickness of less than or equal to 1000 micrometers (μm). A preferred thickness of the glass substrate 10 is less than or equal to 700 micrometers (μm). The glass substrate 10 is processed by a Bessel beam laser to form a pilot through via 12 and a modification region 14 surrounding the pilot through via 12, and then is etched to remove the modification region 14 to enlarge the pilot through via 12 to form a through glass via 15 having a diameter ranging from 25 micrometers (μm) to 200 micrometers (μm).

The Bessel beam laser generates a Bessel beam 30 from a Gaussian beam passing through a Bessel beam lens module 20 to convert to the Bessel beam 30. The Bessel beam lens module 20 may be a conventional Bessel beam lens module. A focal line length L of the Bessel beam 30 is larger than or equal to the thickness of the glass substrate 10. The focal line length L of the Bessel beam 30 is selected according to the thickness of the glass substrate 10. For example, to process a glass substrate 10 having a thinner thickness, the Bessel beam 30 having a shorter focal line length L may be used, and to process a glass substrate 10 having a thicker thickness, the Bessel beam 30 having a longer focal line length L may be used. The Bessel Beam laser has a pulse width ranging from 10 picoseconds (ps, 10⁻¹² seconds) to 20 picoseconds.

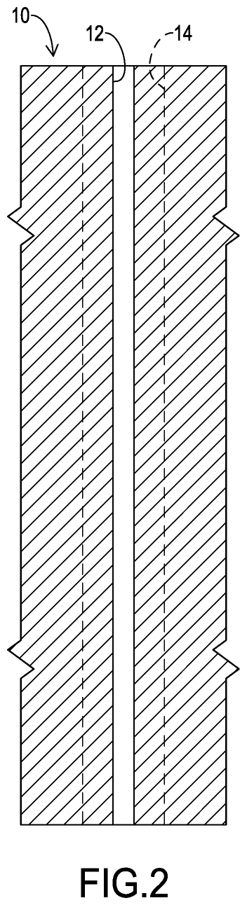

While the Bessel beam 30 passes through the glass substrate 10, the glass substrate 10 absorbs energy from the Bessel beam 30 and rapidly melts, vaporizes, and is modified to form a pilot through via 12 and a modification region 14 surrounding the pilot through via 12 as shown in FIG. 2.

If energy applied to the glass substrate 10 is just over a modification threshold of the glass material thereof, the glass substrate 10 will gain energy just enough to form the pilot through via 12 and the modification region 14, thereby avoiding the glass substrate 10 being damaged by excessive energy. The Bessel beam laser outputs energy ranging from 130 micro Joules to 220 micro Joules, per pulse width and per millimeter of the focal line length L of the Bessel beam 30 (130-220 μJ/mm). Preferably, the Bessel beam laser outputs energy ranging from 130 to 140 micro Joules, per pulse width and per millimeter of the focal line length L of the Bessel beam 30 (130-140 μJ/mm) when the pulse width is 10 ps. The Bessel beam laser outputs energy ranging from 155 to 220 micro Joules, per pulse width and per millimeter of the focal line length L of the Bessel beam 30 (155-220 μJ/mm) when the pulse width is 20 ps.

Generally, if the glass substrate 10 is processed by a pulse laser having a shorter pulse width with a higher peak power, a higher laser fluence is instantaneously applied into the glass substrate 10. The glass substrate 10 can instantaneously absorb laser energy for modification to reduce the laser energy transmitted to the surrounding region in the glass substrate 10 and to reduce energy waste. So smaller energy can be applied to the glass substrate 10 to reach the modification threshold of the glass material thereof to form the pilot through via 12, and a heat affected zone in the glass substrate 10 will be smaller. If the pulse width is shorter than a thermalization time of the glass material, defects caused by the thermal effect will be reduced, thereby reducing glass cracking.

The following experiments are respectively using pulse widths of 10 ps and 7 ps of the Bessel beam laser to form a through glass via 15 to confirm influences on the roughness of an interior surface of the through glass via 15 according to different pulse widths of the Bessel beam laser.

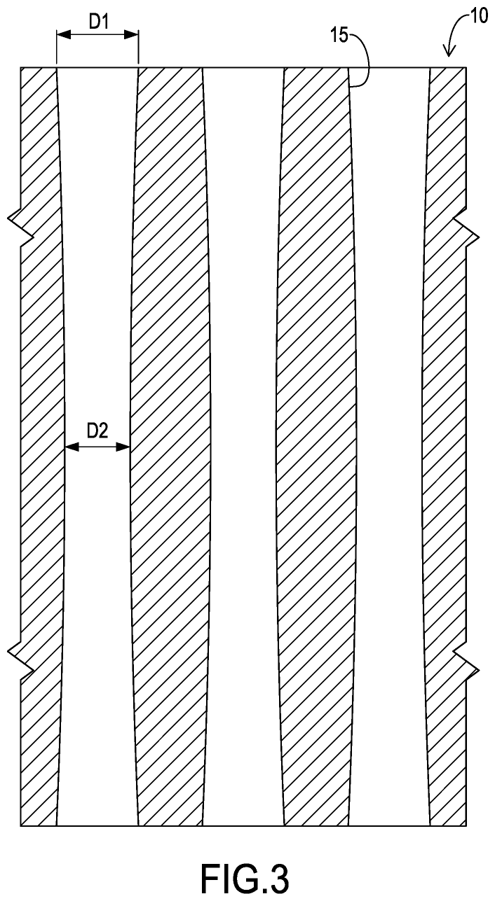

Experiment 1: the glass substrate 10 is made of borosilicate glass, has a thickness being 500 μm, and is processed by the Bessel beam laser to form the pilot through via 12, and then is processed by etching to enlarge the pilot through via 12 to form the through glass via 15 having diameter of 50 μm as shown in FIG. 3. Wherein the pulse width of the Bessel beam laser is 10 ps, the focal line length L of the Bessel beam 30 is 500 μm, the Bessel beam laser outputs energy ranging from 65 μJ to 70 μJ per pulse width, in other words, the Bessel beam laser outputs energy ranging from 130 μJ to 140 μJ per pulse width and per millimeter of the focal line length L of the Bessel beam 30. Repetition frequency of the Bessel beam laser is 100 kHz to 1 MHz, which is 0.1 million to 1 million pulses being outputted in 1 second. Pulse repetition interval (PRI) is 1 microsecond (μs) to 10 μs.

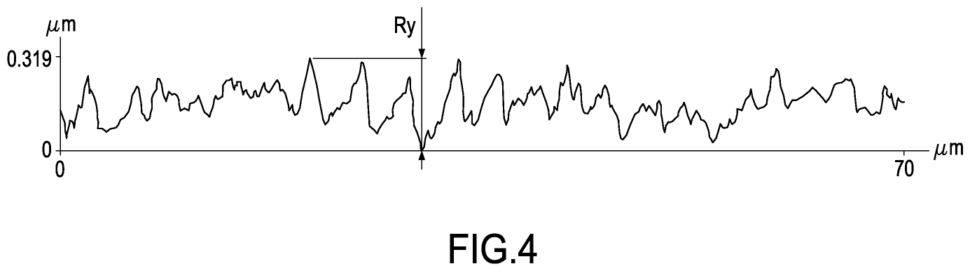

With reference to FIGS. 3 and 4, FIG. 4 shows the roughness chart of the interior surface of the through glass via 15 measured along a longitudinal direction of the through glass via 15. In a range of the length of the through glass via 15 along the longitudinal direction thereof being 70 μm, the maximum peak Ry, which is a distance between the tallest peak and the lowest valley measured in vertical direction as shown in FIG. 4, of the interior surface of the through glass via 15 is 0.31 μm. Ten-point mean roughness (Rz), which is the sum of an average peak obtained among 5 tallest peaks and an average valley obtained among 5 lowest valleys, is from 0.2 μm to 0.3 μm. A middle diameter D2 of the through glass via 15 is 89% of an opening diameter D1 thereof

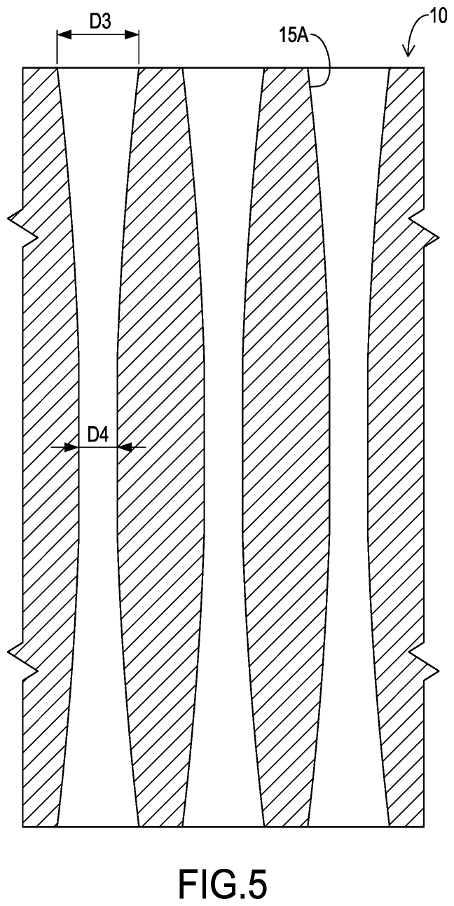

Experiment 2: the glass substrate 10 is made of borosilicate glass, has a thickness of 500 μm, and is processed by the Bessel beam laser to form the pilot through via 12, and then is processed by etching to enlarge the pilot through via 12 to form the through glass via 15A having a diameter of 50 μm as shown in FIG. 5. Wherein the pulse width of the Bessel beam laser is 7 ps, the focal line length L of the Bessel beam 30 is 500 μm, the Bessel beam laser outputs energy ranging from 62.5 μJ to 67.5 μJ per pulse width, in other words, the Bessel beam laser outputs energy 125 μJ to 135 μJ per pulse width and per millimeter of the focal line length L of the Bessel beam 30. Repetition frequency of the Bessel beam laser is 100 kHz to 1 MHz, which is 0.1 million to 1 million pulses being outputted in 1 second. Pulse repetition interval (PRI) is 1 μs to 10 μs.

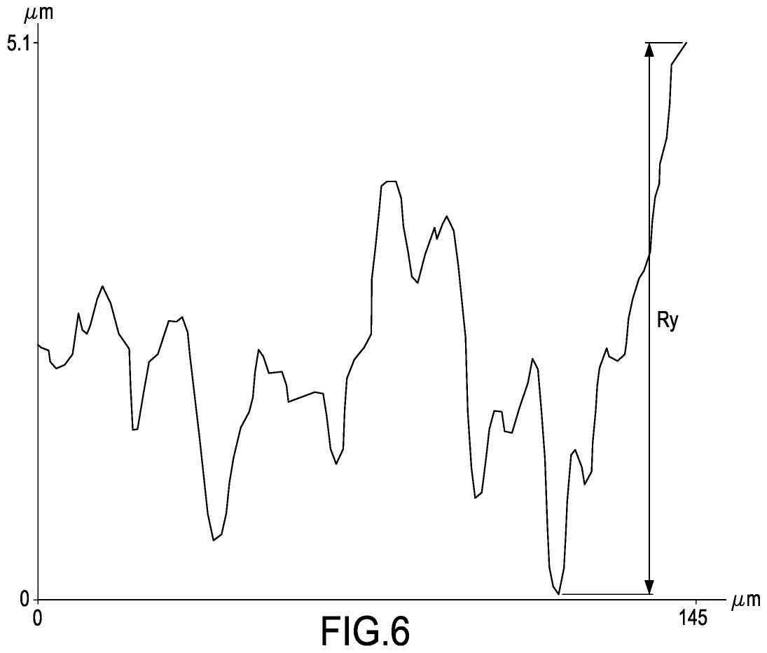

With reference to FIGS. 5 and 6, FIG. 5 shows the roughness chart of the interior surface of the through glass via 15A measured along a longitudinal direction of the through glass via 15A. In a range of the length of the through glass via 15A along the longitudinal direction thereof being 146 μm, the maximum peak Ry, which is a distance between the tallest peak and the lowest valley measured in the vertical direction as shown in FIG. 6, of the interior surface of the through glass via 15A is 5.1 μm. Ten-point mean roughness (Rz) is from 3.1 μm to 5.1 μm. A middle diameter D4 of the through glass via 15A is 70% of an opening diameter D3 thereof.

With the above mentioned experiments, the ten-point mean roughness (Rz) of the through glass via 15, which is formed by the Bessel beam laser having the pulse width of 10 ps, is less than 1 μm, and the ten-point mean roughness (Rz) of the through glass via 15A, which is formed by the Bessel beam laser having the pulse width of 7 ps, is over 1 μm, even up to 5 μm. Accordingly, the through glass via 15A formed by the Bessel beam laser having the pulse width of less than 10 ps to process the glass substrate 10 does not have a smooth interior surface as good as the through glass via 15 formed by the Bessel beam laser having the pulse width of 10 ps.

It can be presumed that, the laser fluence of the Bessel beam laser can be instantaneously concentrated with shorter of the pulse width thereof to reduce the defects causing by the thermal effect. However, if the pulse width of the Bessel beam laser is less than 10 ps, due to high instantaneous laser fluence, instantaneous intensity of the Bessel beam 30 is too high, thereby causing excessive destructive power applied to the glass substrate 10 to crack the glass substrate 10 and increasing the roughness of the interior surface of the through glass via 15A. Accordingly, the through glass via 15A, which is formed by using the pulse width of the Bessel beam laser being less than 10 ps, cannot have the interior surface as smooth as the interior surface of the through glass via 15, which is formed by using the pulse width of the Bessel beam laser range from 10 ps to 20 ps.

The glass substrate 10 needs enough laser fluence for modification, which is etched to form the through glass via 15. However, if the pulse width of the Bessel beam 30 is too long, the heat affected zone in the glass substrate 10 will be larger while energy absorption, thereby increasing cracks in the glass substrate 10. If the pulse width of the Bessel beam 30 is too short, the instantaneous intensity of the Bessel beam 30 will be too high to damage the glass substrate 10, thereby increasing cracks in the glass substrate 10.

Accordingly, a preferable pulse width of the Bessel beam laser, which ranges from 10 ps to 20 ps to, is selected to process the glass substrate 10, such that the defects caused by the thermal effect and the cracks caused by excessive instantaneous intensity of the Bessel beam 30 can be reduced during the glass substrate 10 absorbing energy for modification. After the etching process, the through glass via 15 with the smooth interior surface can be formed, and the ten-point mean roughness (Rz) of the interior surface of the through glass via 15 is less than 1 μm.

What is claimed is:

1. A method of Bessel beam laser processing for forming through glass vias, being adapted for processing a glass substrate having a thickness of less than or equal to 1000 micrometers, the glass substrate processed by a Bessel beam laser to form a pilot through via, and etched to enlarge the pilot through via to form a through glass via having a diameter ranging from 25 micrometers to 200 micrometers, wherein:
the Bessel beam laser has a pulse width ranging from 10 picoseconds to 20 picoseconds and is converted to form a Bessel beam via a Bessel beam lens module, a focal line length of the Bessel beam is larger than or equal to the thickness of the glass substrate, and the Bessel beam passes through the glass substrate to form the pilot through via.

2. The method of Bessel beam laser processing for forming through glass vias as claimed in claim 1, wherein the Bessel beam laser outputs energy ranging from 130 micro Joules to 220 micro Joules, per pulse width and per millimeter of the focal line length of the Bessel beam.

3. The method of Bessel beam laser processing for forming through glass vias as claimed in claim 1, wherein the Bessel beam laser outputs energy ranging from 130 micro Joules to 140 micro Joules, per pulse width and per millimeter of the focal line length of the Bessel beam when the pulse width is 10 picoseconds.

4. The method of Bessel beam laser processing for forming through glass vias as claimed in claim 1, wherein the Bessel beam laser outputs energy ranging from 155 micro Joules to 220 micro Joules, per pulse width and per millimeter of the focal line length of the Bessel beam when the pulse width is 20 picoseconds.

5. The method of Bessel beam laser processing for forming through glass vias as claimed in claim 1, wherein the thickness of the glass substrate is less than or equal to 700 micrometers.

6. The method of Bessel beam laser processing for forming through glass vias as claimed in claim 2, wherein the thickness of the glass substrate is less than or equal to 700 micrometers.

7. The method of Bessel beam laser processing for forming through glass vias as claimed in claim 3, wherein the thickness of the glass substrate is less than or equal to 700 micrometers.

8. The method of Bessel beam laser processing for forming through glass vias as claimed in claim 4, wherein the thickness of the glass substrate is less than or equal to 700 micrometers.
